(19) United States
(12) Patent Application Publication
(10) Pub. No.: US 2024/0266654 A1
(43) Pub. Date: Aug. 8, 2024

(54) BATTERY AND METHOD FOR PRODUCING BATTERY

(71) Applicant: TOYOTA JIDOSHA KABUSHIKI KAISHA, Toyota-shi Aichi-ken (JP)

(72) Inventors: Takaaki GOTO, Seto-shi Aichi-ken (JP); Yoshiro OBAYASHI, Toyota-shi Aichi-ken (JP); Kazuhito KATO, Toyota-shi Aichi-ken (JP)

(73) Assignee: TOYOTA JIDOSHA KABUSHIKI KAISHA, Toyota-shi Aichi-ken (JP)

(21) Appl. No.: 18/427,125

(22) Filed: Jan. 30, 2024

(30) Foreign Application Priority Data
Feb. 7, 2023 (JP) 2023-016823

(51) Int. Cl. H01M 50/193; H01M 4/13; H01M 50/105; H01M 50/119; H01M 50/121; H01M 50/124; H01M 50/178; H01M 50/186; H01M 4/02

(52) U.S. Cl. CPC H01M 50/193; H01M 4/13; H01M 50/105; H01M 50/119; H01M 50/121; H01M 50/124; H01M 50/178; H01M 50/186; H01M 2004/029

(57) ABSTRACT

A battery including: a layered member that includes an electrode layered body including a plurality of electrodes layered in a thickness direction, and a sealing member; a side surface member; and an outer package that covers the layered member and the side surface member. The outer package is arranged to cover a surface configuring an outer periphery of the side surface member, and a surface configuring an outer periphery of the layered member. The side surface member includes a metal foil, and a resin layer that includes a first protruding part and a second protruding part. The sealing member is arranged between the first protruding part and the second protruding part; and each of the first protruding part and the second protruding part are welded to the outer package.

### CROSS-REFERENCE TO RELATED APPLICATIONS

This application is based upon and claims the benefit of priority of the prior Japanese Patent Application No. 2023-016823, filed on Feb. 7, 2023, the entire contents of which are incorporated herein by reference.

### TECHNICAL FIELD

The present disclosure relates to a battery, and a method for producing a battery.

### BACKGROUND ART

Batteries such as a lithium ion secondary battery is usually provided with an electrode body including a cathode current collector, a cathode active material layer, an electrolyte layer, an anode active material layer and an anode current collector. The electrode body is, for example, sealed in an internal space surrounded by an outer package. For example, Patent Literature 1 discloses a lithium polymer secondary battery including an electrode assembly, an outer package surrounding an outer part of the electrode assembly, and a first cover and a second cover sealing the outer package.

### CITATION LIST

### Patent Literature

Patent Literature 1: Japanese Patent Application Laid-Open (JP-A) No. 2011-108623

### SUMMARY OF DISCLOSURE

### Technical Problem

A battery including a layered member in which a sealing member made of resin is arranged along an outer periphery of an electrode layered body has been studied. The sealing member made of a resin is, for example, arranged to seal a liquid electrolyte present inside the electrode layered body. The sealing member made of a resin may be thermally deformed, for example when welding an outer package.

The present disclosure has been made in view of the above circumstances and a main object thereof is to provide a battery in which thermal deformation of a sealing member is inhibited.

### Solution to Problem

(1)

A battery including: a layered member that includes an electrode layered body including a plurality of electrodes electrode layered in a thickness direction, and a sealing member made of a resin arranged along an outer periphery of the electrode layered body; a side surface member arranged at a side surface part of the layered member; and an outer package that covers the layered member and the side surface member, wherein when the battery is viewed from a side surface which is the side surface member side, the outer package is arranged to cover a surface configuring an outer periphery of the side surface member, and a surface configuring an outer periphery of the layered member; the side surface member includes a metal foil, and a resin layer arranged on one main surface of the metal foil; the resin layer includes a first protruding part and a second protruding part extending to a first direction orthogonal to the thickness direction; the sealing member is arranged between the first protruding part and the second protruding part; and each of the first protruding part and the second protruding part are welded to the outer package.

(2)

The battery according to (1), wherein the electrode includes a first current collector, and an electrode layer arranged on at least one surface of the first current collector in the thickness direction; the electrode layered body includes a second current collector at an end part in the thickness direction; and the outer package includes an exposing part where the second current collector is exposed in the thickness direction.

(3)

The battery according to (1) or (2), wherein the side surface member is in surface contact with a surface of the sealing member in the first direction.

(4)

The battery according to any one of (1) to (3), wherein the electrode layered body includes a plurality of bipolar electrode as the electrode.

(5)

The battery according to any one of (1) to (4), wherein the battery is a liquid-based battery in which the electrode layered body contains a liquid electrolyte.

(6)

A method for producing the above described battery, the method comprising: a preparing step of preparing the layered member and the side surface member; an arranging step of arranging the side surface member at the side surface part of the layered member so that the sealing member is arranged between the first protruding part and the second protruding part; a covering step of covering the surface configuring the outer periphery of the side surface member and the surface configuring the outer periphery of the layered member with the outer package; and a welding step of welding the outer package to the first protruding part and the second protruding part by heating a part of the outer package that covers the side surface member.

### Effects of Disclosure

The present disclosure exhibits an effect of providing a battery in which thermal deformation of a sealing member is inhibited.

### BRIEF DESCRIPTION OF DRAWINGS

FIG. 1A is a schematic perspective view exemplifying the layered member in the present disclosure.

FIG. 1B is a schematic perspective view exemplifying the layered member and the side surface member in the present disclosure.

FIG. 2A is a schematic perspective view exemplifying the layered member, the side surface member and the outer package in the present disclosure.

FIG. 2B is another schematic perspective view exemplifying the layered member, the side surface member and the outer package in the present disclosure.

FIG. 2C is a schematic cross-sectional view exemplifying the layered member, the side surface member and the outer package in the present disclosure.

FIG. 3A is a schematic plane view exemplifying the layered member in the present disclosure.

FIG. 3B is a schematic cross-sectional view exemplifying the layered member in the present disclosure.

FIG. 4A is a schematic perspective view exemplifying the side surface member in the present disclosure.

FIG. 4B is another schematic perspective view exemplifying the side surface member in the present disclosure.

FIG. 4C is a schematic cross-sectional view exemplifying the side surface member in the present disclosure.

FIG. 4D is another schematic cross-sectional view exemplifying the side surface member in the present disclosure.

FIG. 5A is a schematic perspective view exemplifying the side surface member in the present disclosure.

FIG. 5B is another schematic perspective view exemplifying the side surface member in the present disclosure.

FIG. 6A is a schematic side view exemplifying the battery in the present disclosure.

FIG. 6B is a schematic cross-sectional view exemplifying the battery in the present disclosure.

FIG. 7A is a schematic cross-sectional view exemplifying the battery in the present disclosure.

FIG. 7B is another schematic cross-sectional view exemplifying the battery in the present disclosure.

FIG. 7C is another schematic cross-sectional view exemplifying the battery in the present disclosure.

FIG. 8A is a schematic side view exemplifying the battery in the present disclosure.

FIG. 8B is another schematic side view exemplifying the battery in the present disclosure.

FIG. 8C is another schematic side view exemplifying the battery in the present disclosure.

FIG. 8D is another schematic side view exemplifying the battery in the present disclosure.

FIG. 9A is a schematic side view exemplifying the battery in the present disclosure.

FIG. 9B is another schematic side view exemplifying the battery in the present disclosure.

FIG. 9C is a schematic perspective view exemplifying the battery in the present disclosure.

FIG. 10 is a flow chart exemplifying the method for producing the battery in the present disclosure.

FIG. 11A is a schematic cross-sectional view exemplifying the method for preparing the layered member in the present disclosure.

FIG. 11B is another schematic cross-sectional view exemplifying the method for preparing the layered member in the present disclosure.

FIG. 11C is another schematic cross-sectional view exemplifying the method for preparing the layered member in the present disclosure.

FIG. 12A is a schematic cross-sectional view exemplifying the method for preparing the side surface member in the present disclosure.

FIG. 12B is another schematic cross-sectional view exemplifying the method for preparing the side surface member in the present disclosure.

FIG. 12C is another schematic cross-sectional view exemplifying the method for preparing the side surface member in the present disclosure.

FIG. 13A is a schematic perspective view exemplifying the arranging step in the present disclosure.

FIG. 13B is a schematic perspective view exemplifying the covering step in the present disclosure.

FIG. 13C is a schematic perspective view exemplifying the welding step in the present disclosure.

### DESCRIPTION OF EMBODIMENTS

The battery and the method for producing the battery in the present disclosure will be hereinafter explained in details with reference to drawings. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

### A. Battery

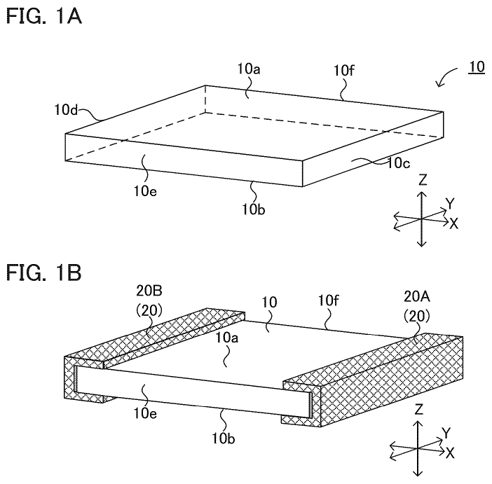

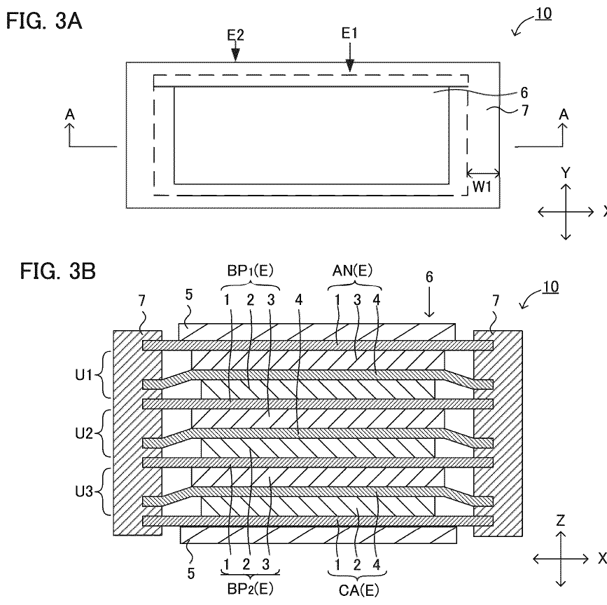

FIGS. 1A and 1B are schematic perspective views exemplifying the layered member and the side surface member in the present disclosure. Layered member 10 shown in FIG. 1A includes top surface part 10a, bottom surface part 10b facing to the top surface part 10a in a thickness direction Z, and four side surface parts (first side surface part 10c, second side surface part 10d, third side surface part 10e and fourth side surface part 10f) that connect the top surface part 10a and the bottom surface part 10b. Also, in FIG. 1B, first side surface member 20A is arranged at the first side surface part 10c in the layered member 10, and second side surface member 20B is arranged at the second side surface part 10d in the layered member 10. Here, as shown in later described FIGS. 3A and 3B, the layered member 10 includes electrode layered body 6 including a plurality of electrodes electrode E layered in the thickness direction Z, and sealing member 7 arranged along outer periphery E1 of the electrode layered body 6 when viewed from the thickness direction Z.

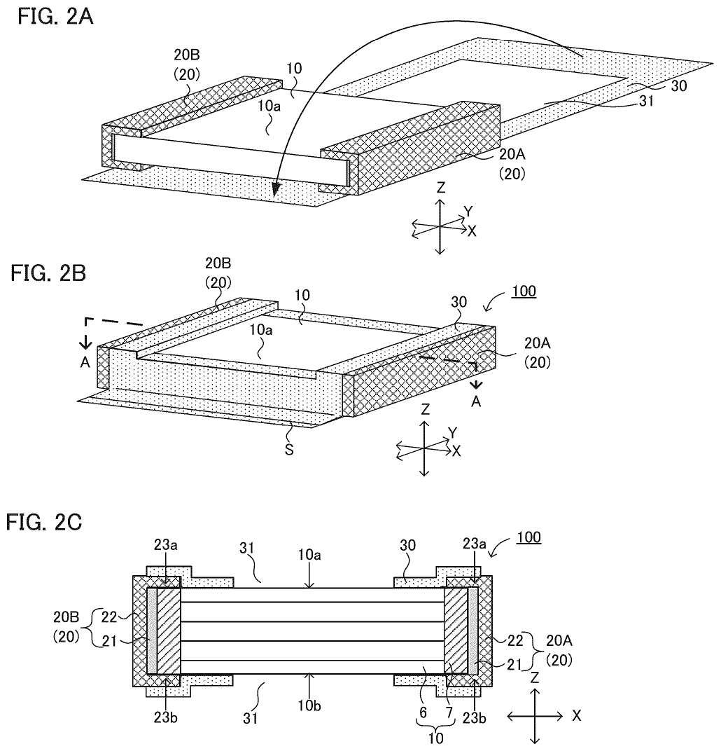

FIGS. 2A to 2C are schematic perspective views and a schematic cross-sectional view exemplifying the battery (electrode layered body, side surface member and outer package) in the present disclosure. FIG. 2C is the cross-sectional view of A-A in FIG. 2B. As shown in FIG. 2A, outer package 30 is, for example, a piece of a film (laminate film). Also, as shown in FIGS. 2B and 2C, the outer package 30 is folded to cover the layered member 10 and the side surface member 20. Incidentally, as shown in FIGS. 2B and 2C, in battery 100, a part of the layered member 10 (a part of the top surface part 10a and the bottom surface part 10b) is exposed from exposing part 31 of the outer package 30.

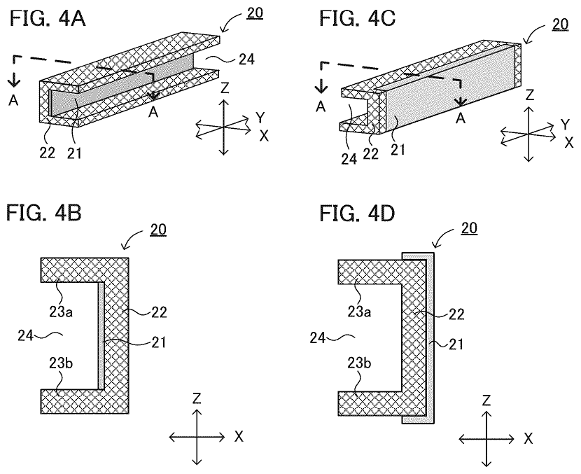

Also, as shown in later described FIGS. 4A to 4D, the side surface member 20 includes metal foil 21, and resin layer 22 arranged on one main surface of the metal foil 21, and the resin layer 22 includes first protruding part 23a and second protruding part 23b extending to a first direction X orthogonal to the thickness direction Z. Then, as shown in FIG. 2C, sealing member 7 is arranged between the first protruding part 23a and the second protruding part 23b, and each of the first protruding part 23a and the second protruding part 23b are welded to the outer package 30.

According to the present disclosure, the side surface member is arranged at the side surface part of the layered member so that the sealing member is arranged between the first protruding part and the second protruding part, and each of the first protruding part and the second protruding part are welded to the outer package, and thus thermal deformation of the sealing member is inhibited in the battery.

Also, in the battery of the present disclosure, the surface (circumference surface) configuring the outer periphery of the side surface member is welded to the outer package. For this reason, for example when compared to the case where outer packages are adhered to form an edge adhered part without using the side surface member, generation of unexpected wrinkles can be inhibited.

### 1. Constitution of Battery

The battery in the present disclosure is provided with at least a layered member including an electrode layered body and a sealing member, a side surface member, and an outer package.

### (1) Layered Member

FIGS. 3A and 3B are a schematic plane view and a schematic cross-sectional view exemplifying the layered member in the present disclosure. FIG. 3B is the cross-sectional view of A-A in FIG. 3A. As shown in FIGS. 3A and 3B, the layered member 10 includes the electrode layered body 6 including a plurality of electrodes E layered in the thickness direction Z, and the sealing member 7 arranged along the outer periphery E1 of the electrode layered body 6 when viewed from the thickness direction Z.

The electrode layered body includes a plurality of electrodes layered in a thickness direction. As shown in FIG. 3B, the electrode E usually includes first current collector 1, and an electrode layer (cathode active material layer 2 and anode active material layer 3) arranged on at least one surface of the first current collector in the thickness direction Z. The electrode layered body 6 shown in FIG. 3B includes, as the electrode E, bipolar electrode BP1, bipolar electrode BP2, cathode side end electrode CA, and anode side end electrode AN. The bipolar electrode BP1 and the bipolar electrode BP2 respectively include first current collector 1, cathode active material layer 2 arranged on one surface of the first current collector 1, and anode active material layer 3 arranged on the other surface of the first current collector 1. The cathode side end electrode CA includes first current collector 1, and cathode active material layer 2 arranged on one surface of the first current collector 1. The anode side end electrode AN includes first current collector 1, and anode active material layer 3 arranged on one surface of the first current collector 1. Meanwhile, although not illustrated in particular, the electrode layered body in the present disclosure may not include the bipolar electrode.

Also, as shown in FIG. 3B, the electrode layered body 6 may include second current collector 5 on an end part (the first current collector 1 in the cathode side end electrode CA and the first current collector 1 in the anode side end electrode AN in FIG. 3B) in the thickness direction Z. When the electrode layered body including such a second current collector is covered with an outer package including an exposing part as shown in FIGS. 1A and 1B, the second current collector can be exposed from the outer package. As a result, large current can be taken out from the top surface and the bottom surface of the layered member. In some embodiments, the thickness of the second current collector is thicker than the thickness of the first current collector. Incidentally, when the electrode layered body includes the second current collector, the second current collector will be a member configuring the top surface and the bottom surface of the layered member.

Also, as shown in FIG. 3B, the electrode layered body 6 usually includes power generating unit U (U1 to U3). The power generating unit U includes cathode active material layer 2, anode active material layer 3, and separator 4 arranged between the cathode active material layer 2 and the anode active material layer 3. The power generating unit U is sealed with the sealing member 7. Also, the inside of the power generating unit U may be filled with a liquid electrolyte. As a result, the cathode active material layer 2, the anode active material layer 3, and the separator 4 are respectively impregnated with the liquid electrolyte. Also, the electrode layered body in the present disclosure may include one of the power generating unit, and may include two or more thereof.

The electrode layered body 6 shown in FIG. 3B includes a plurality of power generating units (U1, U2, U3) layered in the thickness direction Z. As shown in FIG. 3B, the plurality of power generating units may be connected to each other in series. Also, although not illustrated in particular, the plurality of power generating units may be connected to each other in parallel. The plurality of power generating units are each independent so that the liquid electrolyte does not circulate to each other. In FIG. 3B, the plurality of power generating units U1 to U3 are each independent so that the liquid electrolyte does not circulate to each other. For example, the power generating unit U1 and the power generating unit U2 are divided by the first current collector 1 and the sealing member 7, and thus are each independent.

The sealing member is arranged along the outer periphery of the electrode layered body when viewed from the thickness direction. Also, the sealing member is a member configuring the top surface and the bottom surface of the layered member, and also is a member configuring the side surface of the layered member where the later described side surface member is arranged. As shown in FIG. 3A, the sealing member 7 may be arranged along the entire surrounding of the outer periphery E1 of the electrode layered body 6. Meanwhile, although not illustrated, the sealing member may be arranged along a part of the outer periphery of the electrode layered body. Here, as shown in FIG. 3A, when W1 designates the length between the outer periphery E1 of the electrode layered body 6 and the outer periphery E2 of the sealing member 7, the W1 may be the same or different in the surrounding of the layered member.

Here, details will be explained in “B. Method for producing battery”, but in the sealing member, for example, a frame member containing a resin and a liquid injection frame (liquid injection frame sealed with a resin) are included.

The shape of the layered member in a plan view in the thickness direction is, for example, square such as foursquare. Incidentally, the planer shape of the layered member may be, as shown in FIG. 3A, a shape of the region surrounded by the outer periphery E2 (outer periphery of the sealing member 7) of the layered member. The length of each side configuring the shape of the layered member in a plan view (length of each side configuring the outer periphery E2) is, for example, 30 cm or more, may be 60 cm or more, and may be 1 m or more. Meanwhile, the length of each side is, for example, 3 m or less.

### (2) Side Surface Member

The side surface member in the present disclosure is arranged at a side surface part of the layered member. Here, “side surface part of the layered member” refers to, as shown in FIG. 1A, four surfaces (first side surface part 10c, second side surface part 10d, third side surface part 10e and fourth side surface part 10f) of the layered member connecting the top surface part 10a and the bottom surface part 10b of the layered member 10 in the thickness direction Z. Incidentally, in the present specification, the top surface part and the bottom surface part of the layered member may be considered as the main surface part of the layered member.

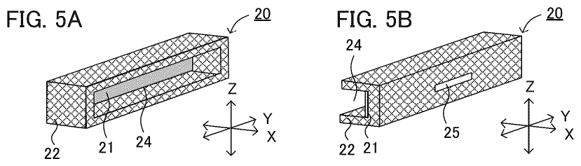

First, the shape of the side surface member in the present disclosure will be explained. FIGS. 4A to 4D are schematic perspective views and schematic cross-sectional views exemplifying the side surface member in the present disclosure. FIG. 4B is a cross-sectional view of A-A in FIG. 4A, and FIG. 4D is a cross-sectional view of A-A in FIG. 4C. Incidentally, for convenience in understanding, FIGS. 4B and 4D are appropriately enlarged compared to FIGS. 4A and 4C. Also, FIGS. 5A and 5B are schematic perspective views exemplifying the side surface member in the present disclosure.

As shown in FIGS. 4A to 4D, the side surface member 20 includes metal foil 21, and resin layer 22 arranged on one main surface of the metal foil 21. Here, “main surface of the metal foil” refers to a surface of the metal foil of which normal direction is parallel to the normal direction of the side surface of the layered member arranged. Also, as shown in FIGS. 4B and 4D, there are first protruding part 23a and second protruding part 23b extending to a first direction X orthogonal to the thickness direction Z. Also, as shown in FIG. 2C, each of the first protruding part 23a and the second protruding part 23b are welded to the outer package 30. The outer package will be described later.

Here, as shown in FIGS. 4A and 4C, the side surface member 20 including the first protruding part 23a and the second protruding part 23b is considered to include groove 24 extending to a second direction Y orthogonal to the first direction X. As shown in FIGS. 4A and 4C, the groove 24 may penetrate the side surface member 20 in the second direction Y. Meanwhile, as shown in FIG. 5A, the groove may not penetrate the side surface member 20 in the second direction Y.

Also, as shown in FIGS. 4A and 4B, the metal foil 21 may be arranged in the groove 24 of the side surface member 20. In other words, the metal foil 21 may be arranged on a surface of the side surface member in the extending direction (left direction of the paper of FIG. 4B) of the first protruding part 23a and the second protruding part 23b. Meanwhile, as shown in FIGS. 4C and 4D, the metal foil 21 may not be arranged in the groove 24 of the side surface member 20. Incidentally, in FIG. 4D, the metal foil 21 is arranged on a surface of the side surface member that is opposite side to the extending direction (left direction of the paper of FIG. 4D) of the first protruding part 23a and the second protruding part 23b. Here, when the metal foil is arranged as shown in FIG. 4D, the metal foil may include an adhesive layer on a surface not contacting the resin layer. When the metal foil includes the adhesive layer, the outer package can be also adhered well to the metal foil interposing the adhesive layer.

In some embodiments, when the side surface member is in a plan view from the normal direction (first direction X in FIGS. 4A to 4D) of the main surface of the metal foil, the area of the metal foil is smaller than the area of the resin layer. The rate of the area of the metal foil with respect to the area of the resin layer is, for example, 0.80 or more and 0.99 or less. In some embodiments, as shown in FIG. 4C, in the direction orthogonal to the normal direction of the main surface of the metal foil (second direction Y in FIGS. 4A to 4D), the length of the metal foil is shorter than the length of the resin layer. In the second direction, the rate of the length of the metal foil with respect to the length of the resin layer is, for example, 0.80 or more and 0.99 or less.

Also, as shown in FIG. 5B, the layered member 20 may 20 may include penetration hole 25 that penetrates the layered member 20 in the first direction X. For example, by connecting a substrate (such as an FPC substrate) extending from the penetration hole with a voltmeter, the voltage of the battery can be controlled.

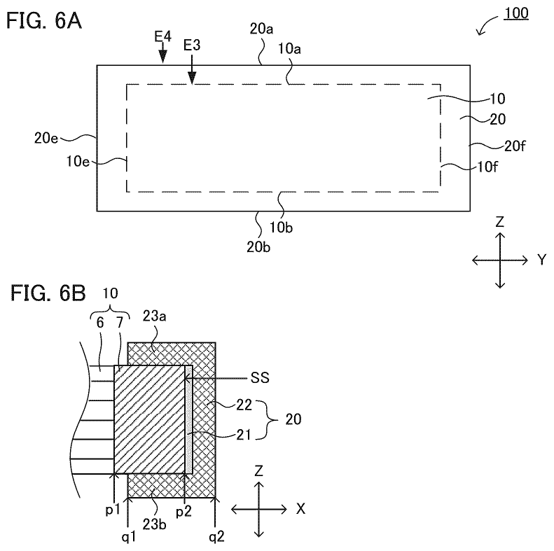

Next, the relation of the sizes of the layered member and the side surface member in the present disclosure will be explained. FIGS. 6A and 6B are a schematic side view and a schematic cross-sectional view exemplifying the battery in the present disclosure. In specific, FIG. 6A is a side view of the battery viewed from the side surface member side, when the side surface member is arranged at the first side surface part or the second side surface part of the layered member. Also, FIG. 6B is a schematic cross-sectional view of the battery part where the layered member is arranged. As shown in FIGS. 6A and 6B, in the side view from the side surface member side, the outer periphery E3 of the layered member 10 may not match the outer periphery E4 of the side surface member. Meanwhile, although not illustrated, the outer periphery of the layered member may match the outer periphery of the side surface member. In other words, in the side view of the battery from the side surface member side, the size (area) of the layered member may be the same as or different from the area of the side surface member. In some embodiments, in the side view, the rate of the area of the side surface member with respect to the area of the layered member is 1.0 or more. The rate of the area may be 1.1 or more, and may be 1.2 or more. Meanwhile, the rate of the area is, for example, 1.5 or less, may be 1.4 or less, and may be 1.3 or less.

As shown in FIG. 2C and FIG. 6B, the sealing member 7 is arranged between the first protruding part 23a and the second protruding part 23b. In other words, the sealing member is inserted in the groove of the side surface member. Here, as shown in FIG. 6B, p1 designates the end part position of the electrode layered body 6 side of the sealing member 7 in the first direction X (normal direction of the side surface where the layered member is arranged), p2 designates the end part position of the opposite side to p1, q1 designates the end part position of the electrode layered body 6 side of the side surface member 20, and q2 designates the end part position of the opposite side to q1. The end part positions p1 and q1 may match. Meanwhile, the end part position q1 may be in p2 side on the basis of p1, and may be in the electrode layered body 6 side on the basis of p1. In some embodiments, as shown in FIG. 6B, the side surface member 20 is in surface contact with surface SS of the sealing member 7 in the first direction X.

Also, in the present disclosure, to one layered member, one side surface member may be arranged, and two or more of the surface member may be arranged. In some embodiments, in the latter case, for example, as shown in FIGS. 1A and 1B, to the layered member 10, a pair of side surface member 20 (first side surface member 20A and second side surface member 20B) is arranged to face to each other. In some embodiments, as shown in FIGS. 1A and 1B, the pair of the side surface member 20 is arranged to face to each other in a longer direction (first direction X) of the layered member 10. Meanwhile, although not illustrated in particular, the pair of the side surface member may be arranged to face to each other in a shorter direction (Y direction in FIGS. 1A and 1B) of the layered member.

### (3) Outer Package

When the battery is viewed from a side surface which is the side surface member side, the outer package in the present disclosure is arranged to cover a surface configuring an outer periphery of the side surface member, and a surface configuring an outer periphery of the layered member. For example, as shown in FIG. 1B and FIG. 6A, when the side surface member 20 is arranged at the first side surface part 10c or the second side surface part 10d of the layered member 10, the surfaces configuring the outer periphery E3 of the layered member 10 are the top surface part 10a, the bottom surface part 10b, the third side surface part 10e and the fourth side surface part 10f. Also, the surfaces configuring the outer periphery E4 of the side surface member 20 are surface parts 20a, 20b, 20e, and 20f of the side surface member respectively facing to the top surface part 10a, the bottom surface part 10b, the third side surface part 10e and the fourth side surface part 10f of the layered member.

In some embodiments, the outer package is a laminate film. Also, the outer package may be a single member configured by a piece of laminate film, and may be a composite member configured by two pieces of laminate film. In the former case, as shown in FIG. 2A, the layered member and the side surface member may be covered by folding a piece of laminate film. Also, in the latter case, the layered member and the side surface member may be covered by sandwiching the layered member and the side surface member with two pieces of laminate film. Details of the laminate film will be described later.

Also, when the layered member includes the second current collector, as shown in FIGS. 2A to 2C, the outer package 30 may include exposing part 31 where the second current collector is exposed in the thickness direction. When the outer package includes the exposing part, the number of the exposing part may be one and may be two. The reason therefor is to expose the second current collector in each of the top surface part and the bottom surface part of the layered member, and current can be taken out via the second current collector.

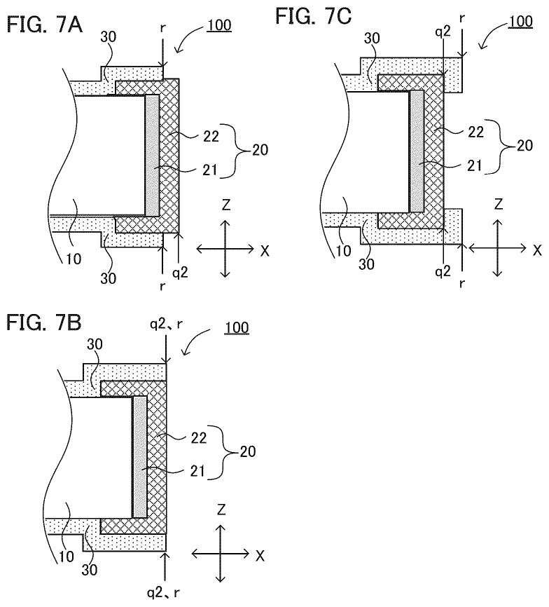

FIGS. 7A to 7C are schematic cross-sectional views exemplifying the battery in the present disclosure. As shown in FIG. 7A, when the battery is viewed from the cross-section of the thickness direction, end part position r of the outer package 30 in the side surface member 20 side may be closer to the layered member 10 side on the basis of end part position q2 of the side surface member 20 that is opposite side to the layered member 10. The q2 is as described above. In other words, when the battery is in a plan view from the thickness direction, the outer package 30 may cover a part of the side surface member 20. In this case, a part of the side surface member 20 (part not covered with the outer package 30) is exposed. Meanwhile, as shown in FIG. 7B, the end part position r of the outer package 30 may match the end part position q2 of the layered member 20, and as shown in FIG. 7C, may be in outer side on the basis of the end part position q2. In other words, when the battery is in a plan view from the thickness direction, the outer package 30 may cover the whole of the side surface member 20.

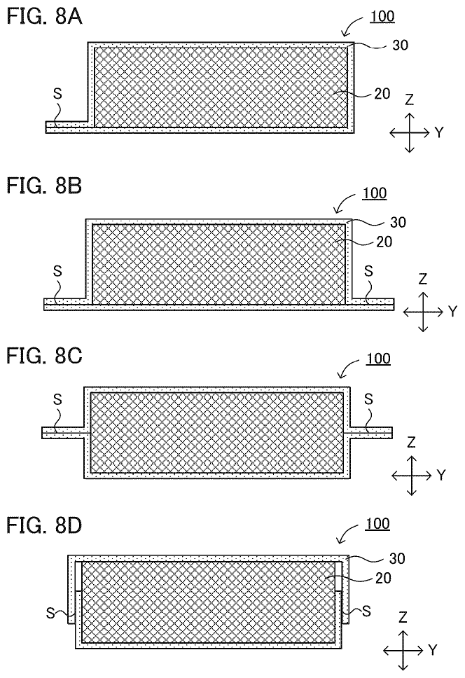

FIGS. 8A to 8D are schematic side views of the battery in the present disclosure, which is viewed from the side surface member. As shown in FIGS. 8A to 8D and FIG. 2B, battery 100 may include end parts adhering part S where the end parts of the outer package 30 are welded to each other. As shown in FIG. 2B and FIG. 8A, when the outer package is a single member (a piece of laminate film), the battery 100 usually includes the end parts adhering part at one point. Meanwhile, when the outer package is a composite member (two pieces of laminate film), as shown in FIGS. 8B to 8D, the battery 100 usually includes the end parts adhering part at two points. Incidentally, as shown in FIG. 2B, usually, the end parts adhering part is formed along the side surface of the layered member where the side surface member is not arranged.

As shown in FIGS. 8A to 8C, the end parts adhering part S in the side view may be formed so as to protrude from the side surface member 20 (and layered member). The surface in which the end parts adhering part S protrudes in the battery may be the bottom surface part of the layered member as shown in FIGS. 8A and 8B, and may be the side surface part of the layered member where the side surface member is not arranged as shown in FIG. 8C. Incidentally, although not illustrated in particular, the protruding end parts adhering part S may be folded according to the shape of the side surface member. The reason therefor is to reduce excessive space. Meanwhile, as shown in FIG. 8D, in the side view, the end parts adhering part S may not protrude from the side surface member 20 (and layered member). In other words, the end parts of the outer package may be welded on surfaces of the layered member and the sealing member.

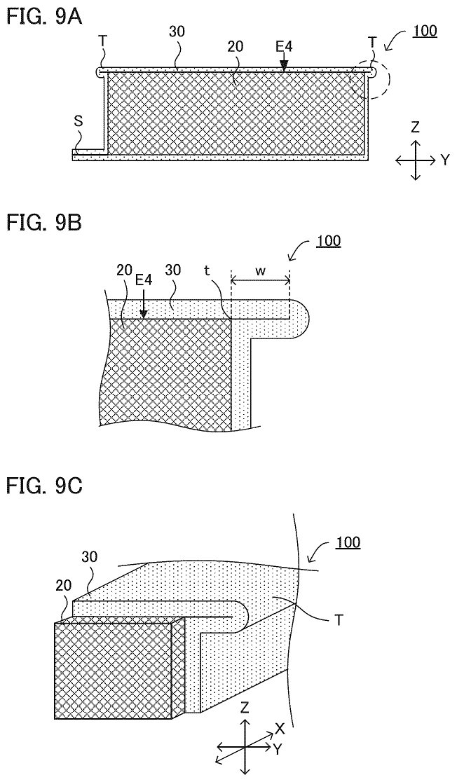

FIGS. 9A to 9C are schematic side views and a schematic perspective view exemplifying the battery in the present disclosure. In specific, FIG. 9A is a schematic side view when the battery is viewed from the layered member side, FIG. 9B is a schematic side view enlarging the dotted line part of FIG. 9A, and FIG. 9C is a schematic perspective view enlarging the dotted line part of FIG. 9A. As shown in FIG. 9A, the battery 100 may include welded part T where inner surfaces (surface in the side surface member 20 side) of the outer package 30 are welded to each other, on the side surface member 20. In some embodiments, the welded surface in the welded part T does not include a void. When the battery includes the welded part on the side surface member, degrade in sealability of the battery can be inhibited.

In some embodiments, as shown in FIGS. 9B and 9C, the welded part T is formed in the corner part of the outer periphery E4 of the side surface member 20, and that the welded part T is arranged in the corner part configuring the outer periphery E4 of the side surface member 20. In some embodiments, the corner part configuring the outer periphery E4 of the side surface member 20 matches the end part t of the welded surface in the welded part T. As shown in FIG. 9B, the width of the welded surface in the welded part T is regarded as w. The width w is, for example, 0.1 mm or more, may be 0.3 mm or more, and may be 0.6 mm or more. Meanwhile, the width w is, for example, 1.2 mm or less.

In some embodiments, as shown in FIG. 9C, the welded part T is formed along with the extending direction (first direction X in FIG. 9B) of the side surface of the electrode layered body (not illustrated) where the side surface member 20 is not arranged.

### 2. Members of Battery

The battery in the present disclosure is provided with a layered member including an electrode layered body and a sealing member, a side surface member and an outer package.

### (1) Electrode Layered Body

As described above, the electrode layered body in the present disclosure usually includes a first current collector, electrode layers (cathode active material layer and anode active material layer), and a separator layer. Also, as described above, a second current collector may be included if necessary.

The cathode active material layer contains at least a cathode active material. The cathode active material layer may further contain at least one of a conductive material, an electrolyte and a binder. Examples of the cathode active material may include an oxide active material. Examples of the oxide active material may include a rock salt bed type active material such as LiNi_{1/3}Co_{1/3}Mn_{1/3}O₂, a spinel type active material such as LiMn₂O₄, and an olivine type active material such as LiFePO₄. Also, as the cathode active material, sulfur (S) may be used. Examples of the shape of the cathode active material may include a granular shape.

Examples of the conductive material may include a carbon material. In some embodiments, the electrolyte is a solution electrolyte (liquid electrolyte). The liquid electrolyte contains, for example, a supporting electrolyte such as LiPF₆, and a solvent such as a carbonate-based solvent. Also, examples of the binder may include a rubber-based binder and a fluoride-based binder.

The anode active material layer contains at least an anode active material. The anode active material layer may further contain at least one of a conductive material, an electrolyte, and a binder. Examples of the anode active material may include a metal active material such as Li and Si, a carbon active material such as graphite, and an oxide active material such as Li₄Ti₅O₁₂. Examples of the shape of the anode active material may include a granular shape and a foil shape. The conductive material, the electrolyte, and the binder are in the same contents as those described above.

There are no particular limitations on the separator if it is a material through which the liquid electrolyte can pass, and conventionally known materials can be used.

The first current collector and the second current collector may be a cathode current collector, and may be an anode current collector. Examples of the material for the cathode current collector may include a metal such as aluminum, SUS, and nickel. Examples of the material for the anode current collector may include a metal such as copper, SUS, and nickel.

### (2) Sealing Member

The sealing member is a member made of a resin. Examples of the resin may include a thermoplastic resin. Examples of the thermoplastic resin may include olefin-based resin such as polyethylene and polypropylene.

### (3) Side Surface Member

The side surface member includes a metal foil and a resin layer. The material of the metal foil is not particularly limited, and examples thereof may include a metal such as aluminum, SUS, and nickel. Also, examples of the material of the resin layer may include the above described thermoplastic resin.

### (4) Outer Package

In some embodiments, the outer package in the present disclosure is a laminate film including at least a structure in which a heat welding layer and a metal layer are laminated. Also, the laminate film may include layers in the order of the heat welding layer, the metal layer and a resin layer along with the thickness direction. Examples of materials for the heat welding layer may include an olefin-based resin such as polypropylene (PP) and polyethylene (PE). Examples of the metals for the metal layer may include aluminum, an aluminum alloy, and stainless steel. Examples of materials for the resin layer may include polyethylene terephthalate (PET) and nylon. The thickness of the heat welding layer is, for example, 40 μm or more and 100 μm or less. The thickness of the metal layer is, for example, 30 μm or more and 60 μm or less. The thickness of the resin layer is, for example, 20 μm or more and 60 μm or less. The thickness of the outer package is, for example, 80 μm or more and 250 μm or less.

### (5) Battery

The battery in the present disclosure is typically a lithium ion secondary battery. In some embodiments, the battery is a liquid-based battery in which the electrode layered body contains a liquid electrolyte. Examples of the applications of the battery may include a power source for vehicles such as hybrid electric vehicles (HEV), plug-in hybrid electric vehicles (PHEV), battery electric vehicles (BEV), gasoline-fueled automobiles and diesel powered automobiles. In some embodiments, the battery is used as a power source for driving hybrid electric vehicles (HEV), plug-in hybrid electric vehicles (PHEV), and battery electric vehicles (BEV). Also, the battery in the present disclosure may be used as a power source for moving bodies other than vehicles (such as rail road transportation, vessel and airplane), and may be used as a power source for electronic products such as information processing equipment.

### B. Method for Producing Battery

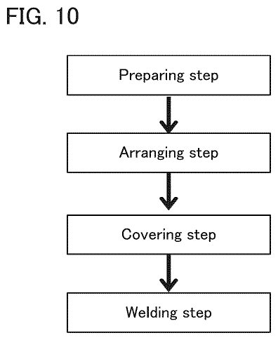

As shown in FIG. 10, the method for producing a battery in the present disclosure is the method for producing the above described battery, the method comprises: a preparing step of preparing the layered member and the side surface member; an arranging step of arranging the side surface member at the side surface part of the layered member so that the sealing member is arranged between the first protruding part and the second protruding part; a covering step of covering the surface configuring the outer periphery of the side surface member and the surface configuring the outer periphery of the layered member with the outer package; and a welding step of welding the outer package to the first protruding part and the second protruding part by heating a part of the outer package that covers the side surface member.

### 1. Preparing Step

The preparing step in the present disclosure is a step of preparing the layered member and the side surface member.

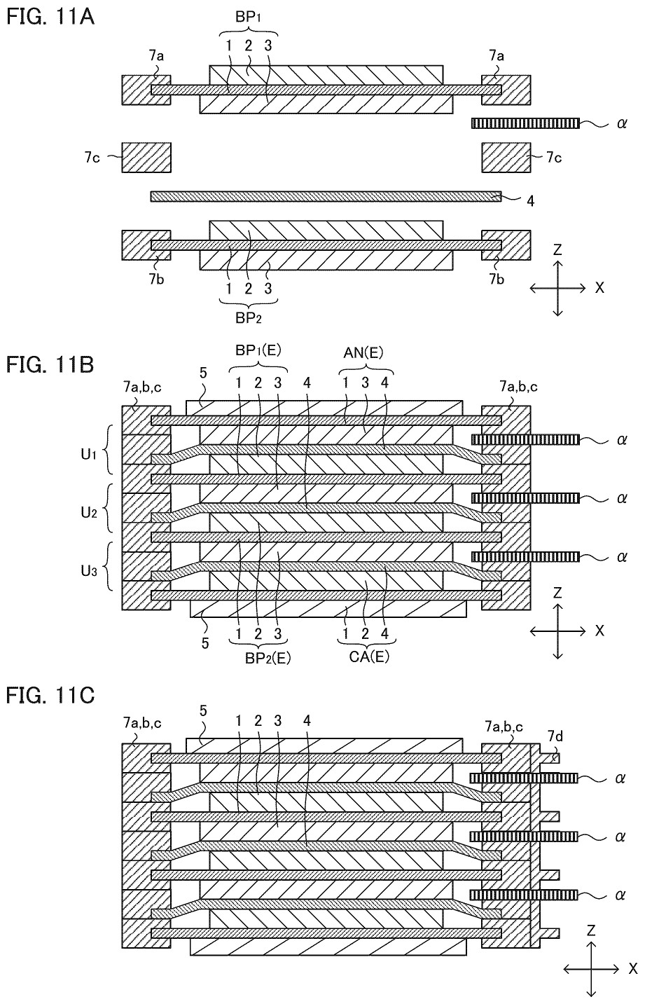

FIGS. 11A to 11C are schematic cross-sectional views exemplifying the method for preparing the layered member in the present disclosure. In particular, FIGS. 11A to 11C show a method for preparing a layered member that includes a bipolar electrode and also contains a liquid electrolyte. First, as shown in FIG. 11A, bipolar electrode BP1 and bipolar electrode BP2 are prepared. The bipolar electrode BP1 and the bipolar electrode BP2 respectively include frame member 7a and 7b for forming sealing member, arranged along with the outer periphery of the first current collector 1. Next, the anode active material layer 3 in the bipolar electrode BP1 and the cathode active material layer 2 in the bipolar electrode BP2 are faced to each other interposing separator 4. On this occasion, at least a part of the outer periphery of the separator 4 is arranged between the frame member 7a and the frame member 7b. Also, as shown in FIG. 11A, nest α and frame member (spacer) 7c are arranged between the frame member 7a in the bipolar electrode BP1 and the frame member 7b in the bipolar electrode BP2. Next, although not illustrated in particular, cathode side end electrode CA and anode side end electrode AN are layered, and the second current collector (cathode current collector) is layered on the cathode side end electrode CA, and the second current collector (anode current collector) is layered on the anode side end electrode AN. After that, a plurality of frame members layered are welded so as to obtain a structure body including the nest α as shown in FIG. 11B. Next, as shown in FIG. 11C, by arranging liquid injection frame 7d including a resin in the surrounding of the nest α and then pulling out the nest α, penetration hole β that penetrates the sealing member is formed. Then, although not illustrated in particular, a liquid electrolyte is injected from the penetration hole, and after the injection, the liquid injection frame together with the penetration hole are sealed with a resin. In this manner, layered member 10 as shown in FIG. 3B is obtained. In this manner, the sealing member in the present disclosure may include the above described frame member and liquid injection frame (liquid injection frame sealed with a resin).

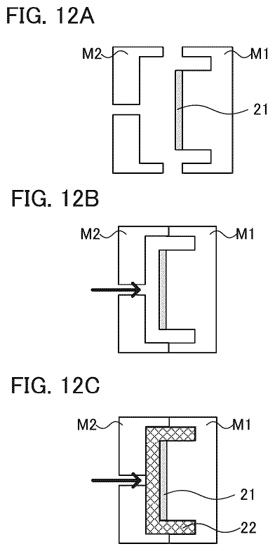

FIGS. 12A to 12C are schematic cross-sectional views exemplifying the method for preparing the side surface member in the present disclosure. As shown in FIGS. 12A to 12C, the side surface member in the present disclosure may be prepared by an injection molding. As shown in FIGS. 12A and 12B, molds M1 and M2 are arranged to face to each other. As shown in FIG. 12A, metal foil 21 is arranged in one mold M1 in advance. Then, as shown in FIGS. 12B and 12C, a resin is injected. After that, by taking out the molds M1 and M2, side surface member 20 as shown in FIGS. 4A and 4B is obtained. Incidentally, although not illustrated, a metal foil may be adhered to the injection-molded resin layer later. In this manner, the side surface member as shown in FIGS. 4C and 4D is obtained.

### 2. Arranging Step

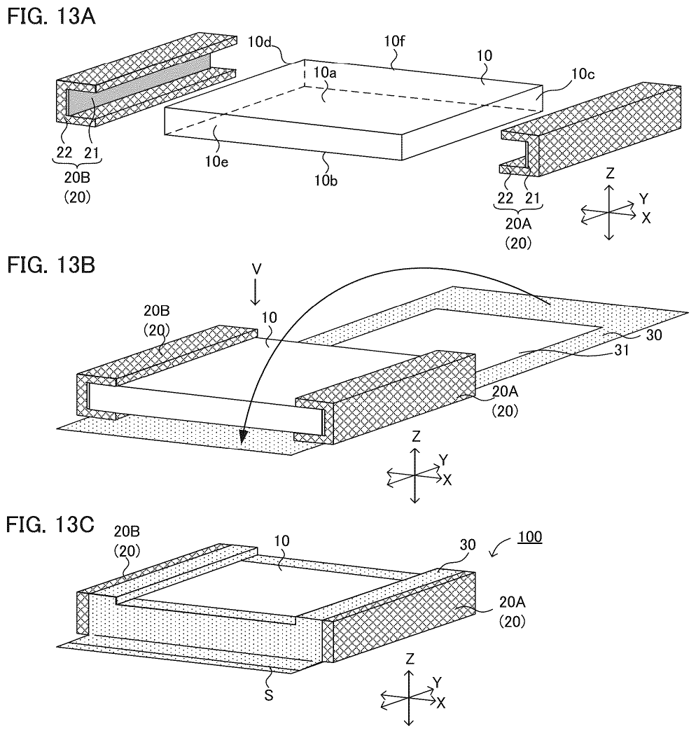

An arranging step in the present disclosure is a step of arranging the side surface member at the side surface part of the layered member so that the sealing member is arranged between the first protruding part and the second protruding part. FIGS. 13A to 13C are schematic perspective views exemplifying the arranging step and the covering step in the present disclosure. As shown in FIGS. 13A and 13B, first side surface member 20A and second side surface member 20B are arranged at the side surface part (first side surface part 10c and second side surface part 10d) of the layered member 10 prepared, and a sealing member of the layered member is inserted to a groove of the side surface member.

### 3. Covering Step

The covering step in the present disclosure is a step of covering the surface configuring the outer periphery of the side surface member and the surface configuring the outer periphery of the layered member with the outer package. The surface configuring the outer periphery of the side surface member and the surface configuring the outer periphery of the layered member are as described above. As shown in FIGS. 13B and 13C, a piece of outer package 30 is winded to structure body V including layered member 10 and side surface member 20 so as to cover the structure body. The outer package is as described above. Also, in the covering step, the above described end parts adhering part and the heat welding part may be formed. In some embodiments, the covering step is performed under a reduced pressure environment. The reason therefor is to further improve the adhesiveness of the outer package.

### 4. Welding Step

The welding step in the present disclosure is a step of welding the outer package to the first protruding part and the second protruding part by heating a part of the outer package that covers the side surface member. In some embodiments, the welding step is performed under a reduced pressure environment similarly to the covering step.

In the welding step, as shown in FIG. 13C, the part of the outer package 30 covering the side surface member 20 is heated. Thus, there is no risk of directly heating the sealing member in the layered member, which can prevent the thermal deformation of the sealing member.

### 5. Battery

The battery to be produced by the above described steps is as described in “A. Battery”.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### REFERENCE SINGS LIST

1 first current collector
2 cathode active material layer
3 anode active material layer
4 separator
5 second current collector
E electrode
U power generating unit
6 electrode layered body
7 sealing member
10 layered member
20 side surface member
30 outer package
100 battery

What is claimed is:

1. A battery comprising:
a layered member that includes an electrode layered body including a plurality of electrodes layered in a thickness direction, and a sealing member made of a resin arranged along an outer periphery of the electrode layered body;
a side surface member arranged at a side surface part of the layered member; and
an outer package that covers the layered member and the side surface member, wherein
when the battery is viewed from a side surface which is the side surface member side, the outer package is arranged to cover a surface configuring an outer periphery of the side surface member, and a surface configuring an outer periphery of the layered member;
the side surface member includes a metal foil, and a resin layer arranged on one main surface of the metal foil;
the resin layer includes a first protruding part and a second protruding part extending to a first direction orthogonal to the thickness direction;
the sealing member is arranged between the first protruding part and the second protruding part; and
each of the first protruding part and the second protruding part are welded to the outer package.

2. The battery according to claim 1, wherein
each of the plurality of electrodes includes a first current collector, and an electrode layer arranged on at least one surface of the first current collector in the thickness direction;
the electrode layered body includes a second current collector at an end part in the thickness direction; and
the outer package includes an exposing part where the second current collector is exposed in the thickness direction.

3. The battery according to claim 1, wherein the side surface member is in surface contact with a surface of the sealing member in the first direction.

4. The battery according to claim 1, wherein the electrode layered body includes a plurality of bipolar electrode as the plurality of electrodes.

5. The battery according to claim 1, wherein the battery is a liquid-based battery in which the electrode layered body contains a liquid electrolyte.

6. A method for producing the battery according to claim 1, the method comprising:
a preparing step of preparing the layered member and the side surface member;
an arranging step of arranging the side surface member at the side surface part of the layered member so that the sealing member is arranged between the first protruding part and the second protruding part;
a covering step of covering the surface configuring the outer periphery of the side surface member and the surface configuring the outer periphery of the layered member with the outer package; and
a welding step of welding the outer package to the first protruding part and the second protruding part by heating a part of the outer package that covers the side surface member.
